(19) United States
(12) Patent Application Publication
(10) Pub. No.: US 2020/0203857 A1
(43) Pub. Date: Jun. 25, 2020

(54) Connection of a Connection Part to a Stranded Wire

(71) Applicant: Auto-Kabel Management GmbH, Hausen i.W. (DE)

(72) Inventor: Oliver Scharkowski, Zell im Wiesental (DE)

(21) Appl. No.: 16/498,795

(22) PCT Filed: Jan. 11, 2018
(86) PCT No.: PCT/EP2018/050600

§ 371 Date: Oct. 21, 2019

(30) Foreign Application Priority Data
Mar. 29, 2017 (DE) 10 2017 106 742.6

(51) Int. Cl. H01R 4/62; H01R 4/18; H01R 4/02; H01R 43/02; H01R 43/048

(52) U.S. Cl. CPC H01R 4/625; H01R 4/183; H01R 4/029; H01R 2201/26; H01R 43/0214; H01R 43/048; H01R 43/0207

(57) ABSTRACT

Connection of a connection wire to a stranded wire, in which a connecting part has a first metallic surface made of a first metal material and a second metallic surface made of a second metal material which is different from the first metal material, the stranded wire is formed from a metal material, the connecting part sheathing the stranded wire is laid with the first metallic surface adjacent to the stranded wire around the stranded wire, and the connecting part is connected to the stranded wire at least in a positive-locking manner.

The subject matter relates to a connection of a connector to a stranded wire and a method of connecting a connector to a stranded wire.

Cascade welding with copper stranded wires, especially using different metals or metal materials, is well known in the vehicle electrical system industry. Different precious metals are usually joined by means of an ultrasonic joining process.

Due to the increasing use of aluminium cables, especially in the area of power transmission cables, such as battery cables, connection technologies have become necessary for such aluminium cables. Especially for aluminium cables with larger cross-sections, e.g. over 30 mm², especially up to 160 mm², e.g. for battery cables, contacting with connection wires of different types is problematic.

Contact corrosion occurs when stranded wires are joined directly to connection wires of different types, e.g. a direct connection between copper and aluminium. Particularly in automotive applications, it can cable to corrosion effects at the joint under the influence of condensation water, for example, which cause the aluminium electrode to dissolve over time. The effect increases with increasing potential difference, e.g. during power transmission of a battery cable.

Thus, the subject matter was based on the object of providing a connection that is permanently stable even in automotive applications and with high potential differences at the transition of the connection.

Particularly in automotive applications and at high currents, the contact resistance at connections between different metallic parts cannot be neglected. At high currents, this contact resistance cables to high potential differences and thus to an increased risk of contact corrosion. The risk of contact corrosion is increased by the use of different metal materials. Finally, in automotive applications, moisture must always be expected in the area of the contact point, which can intensify corrosion due to the electrolyte that forms. However, the durability of the connection is decisive, especially with large cable cross-sections and high currents.

To solve the above object, it is proposed to provide a connection according to claim 1.

It is possible to first bring a stranded wire made of a first metal material into contact with the first metallic surface of a connecting part. The connecting part has a second metallic surface which is formed from a second metal material different from the first metal material. This second surface preferably does not come into contact with the stranded wire, but is used for contacting a connection wire. Stranded wire and connection wire are preferably made of different metal materials. Due to the transition of the metal materials in the area of the connecting part, there is no direct contact between the different metals of the connection wire and the stranded wire. The metallic transition between the first metal material and the second metal material on the connecting part can be sufficiently protected against contact corrosion.

The connection wire can in particular be a stranded wire or a flat wire made of solid material.

It is also possible that the respective transition between two metallic materials is formed with such a small standard potential difference that the risk of contact corrosion is reduced. The standard potential difference between the metal material of the stranded wire and the metal material of the first surface of the connector can have a first amount. The standard potential difference between the first metal material of the connection part and the second metal material of the connection part may have a second amount. The standard potential difference between the second metal material of the connecting part and the metal material of the connection wire can have a third amount. The first, second and third amounts of the standard potential difference can be smaller than the standard potential difference between the metal material of the stranded wire and the metal material of the connection wire.

In particular, the first, second and/or third amount of the standard potential difference is less than 2V, preferably less than 1V. This ensures that a standard potential difference of greater than 2V, preferably 1V, is not present at any metallic transition, thus keeping contact corrosion as low as possible.

It may also make sense for the second amount of the standard potential difference, i.e. between the first metal material of the connection part and the second metal material of the connection part, to be greater than the first amount of the standard potential difference and the third amount of the standard potential difference.

In particular, the second amount of the standard potential difference may be greater than 1.5 V. At the transitions between the first metal material and the stranded wire or the second metal material and the metal material of the connection wire, on the other hand, the first and third amounts of the standard potential difference may be less than 1.5 V. This reduces the contact corrosion potential at the direct contact points between the connecting part and the stranded wire or the connecting part and the connection wire.

The contact corrosion potential is increased in the area of the connecting part. However, as the connecting part can be particularly protected against contact corrosion, especially moisture penetration, the overall risk of joint corrosion can be reduced.

According to the subject matter, it is possible to connect an inner side of the connecting part facing the stranded wire directly to the stranded wire and to connect a surface of the connecting part facing away from the stranded wire directly to the connection wire. The connecting part with its two different surfaces is formed in such a way that the risk of contact corrosion in the entire joint is reduced compared to conventional joints.

The standard potential of the different materials is preferably measured at standard conditions, in particular 25° C., 101.3 kPa, ph=0 and an ionic activity of 1 mol/l. Also a standard hydrogen electrode is also preferably used at standard conditions to determine the respective standard potential of a material. The difference between the standard potentials is then determined on the basis of the potentials of the respective half cells (material to standard hydrogen electrode).

According to an embodiment, it is proposed that the amount of the standard potential difference between the first metal material and the second metal material is greater than 1V, preferably greater than 1.5V. Also, the amount of the standard potential difference between the first metal material and the second metal material may be less than 2.5V. The high standard potential difference at the junction between the first metal material and the second metal material is intended because the connection part may be protected against moisture penetration in the area of the seam or the junction between the two metallic surfaces.

The connection wire is joined to the second metallic surface of the connecting part in a material-locking manner. This joint is often exposed to oxidation-promoting environmental conditions such as moisture, salt and the like. Therefore, this metallic transition should have as low a standard potential difference as possible. For this reason, it is proposed that the amount of the standard potential difference between the metal material of the connection wire and the second metal material is less than 1.5V, in particular less than 1V. Thus the potential difference between the second metal material and the metal material of the connection wire is preferably smaller than the potential difference between the two metal materials of the connecting part.

The amount of the standard potential difference between the first metal material and the metal material of the stranded wire can also be less than 1.5V, preferably less than 1V. In particular, this potential difference can be approximately or equal to 0V, since the two metal materials can also be the same.

This also applies to the metal material of the connection wire and the second metal material. Here, too, the standard potential difference can be close to or equal to 0V if the connection is of a single type.

The connecting part is bimetallic, i.e. made of at least two different metal materials. A bimetal sheet metal strip or a bimetallic coating can be formed in the connecting part. For example, a carrier material can be provided and a metallic coating material. The carrier material may be roll clad with the coating material.

According to an embodiment, the connecting part can be made of a metallic carrier material and a metallic coating material. The carrier material can form the first metal material and the coating material can form the second metal material. It is also possible that the carrier material forms the second metal material and the coating material forms the first metal material. The stranded wire can be made of a metal material, in particular the first or the second metal material. The use of a bimetal sheet strip or a bimetal material as a connecting part is suitable for the contact corrosion-proof joining of a stranded wire with a connection wire.

In particular, an aluminium stranded wire can be used as a stranded wire and a copper wire as a connection wire.

The connection part can be placed on the aluminium stranded wire with its metallic surface similar to that of aluminium and the copper wire can be placed on the other side of the connection part, which is coated with a second metal material. In particular, the connection wire can be welded to the connecting part using ultrasonic welding.

In particular, it is conceivable to use copper or aluminium materials as carrier materials and, for example, to use nickel as coating material. It is also possible to coat the connecting part with nickel on all sides. It is also possible to use brass as the carrier material. At a transition between the carrier material and the coating material, for example, an additional coating, in particular a metallic coating, e.g. of nickel, can be provided.

This connection is particularly suitable for power cables or battery, starter and/or generator cables, especially in motor vehicles. Such cables have a high current carrying capacity and are suitable, for example, for carrying several 100 A over a longer period of time. Therefore, cable cross-sections greater than 50 mm2 are recommended for the stranded wires. On the other hand, the wire cross-section of the stranded wires is preferably smaller than 200 mm2. These stranded wires are particularly suitable for use in automotive applications, as they are subject to stress.

In particular, the stranded wire is an energy cable in a motor vehicle which can be formed as a battery cable, starter-generator cable, battery starter cable, generator-battery cable or the like. The stranded wire can also be installed as an energy backbone in a motor vehicle and, on the basis of this, a wide variety of outlets to a wide variety of consumers can be realised. Also, the connection wire can be formed as a battery cable, starter-generator cable, battery starter cable, generator battery cable or the like. The connection wire can also be installed as an energy backbone in a motor vehicle and, on the basis of this, a wide variety of outgoing circuits to a wide variety of consumers can be implemented through the stranded wire. The connection wire can in particular be a flat cable. A flat cable is formed in one piece from a solid material.

According to an embodiment, the stranded wire is routed in a cable with insulation. The cable is preferably spliced so that the insulation is removed from the stranded wire in a central area between two insulated outer areas. The cable may be surrounded by insulation on both sides of the non-insulated area. It is also possible that the stranded wire is stripped in one area of one end. In the stripped area, the connection can be made with the aid of the connection part, which is preferably bimetallic.

According to an embodiment, it is proposed that the connecting part is placed as a cut-to-length strip around the stranded wire or that the connecting part is placed around the stranded wire from an endless belt and then cut to length or that the connecting part is placed around the stranded wire as a one-piece or two-piece sleeve or as a multi-piece sleeve.

A preferred geometry of the connecting part, in particular as a bimetal sheet metal strip or bimetal material, for a contact corrosion-proof connection of aluminium or copper stranded wires in particular with connection wires made of copper or aluminium can be, for example, a prefabricated, cut-to-length sheet metal strip. This can be wrap around the stranded wire. It is also possible to wrap an endless belt, preferably a sheet metal endless belt, around the stranded wire and cut it to length after wrapping.

Also, sleeve parts, in particular two or more sleeve parts, can be provided for the conductor cross-section of the stranded wire. In particular, they may have an inner radius corresponding to the radius of the stranded wire. The sleeve parts can be positioned on the stranded wire and then connected to the stranded wire in a material-locking manner, preferably by means of welding.

It is also possible that a one-piece sleeve, preferably with a round or polygonal inner and/or outer circumference, is palced around the stranded wire and positioned at the joint. After it has been positioned on the stranded wire, a sleeve can be joined to the stranded wire by means of a suitable joining process in a force-locking, positive-locking and/or material-locking manner. Crimping and/or ultrasonic welding are particularly suitable for joining the connecting part to the stranded wire.

For this reason, it is proposed according to an embodiment that the connection part is crimped around the stranded wire. In particular, the connecting part in the area of an insulation may have an inner circumference corresponding to the outer circumference of the insulation. In particular, the connecting part can be arranged gas-tight on the insulation.

The connecting part can also have at least one flat surface region pointing outwards in the region of the stranded wire, at least one seam of the connecting part being arranged in at least one flat surface region. When joining the connecting part around the stranded wire, preferably at least one seam is formed. This seam is only omitted if a one-piece sleeve is placed around the stranded wire. The seam is preferably arranged in an area that is flat after joining, so that the seam can be welded particularly well on the flat surface area in a subsequent welding process.

The connecting part is first laid loosely around the stranded wire and with the aid of suitable plastic deformation processes, such as crimping, at least positively fitted around the stranded wire. In the insulation area, the cable may have a larger diameter than the stranded wire. When joining the connecting part around the cable, different inner diameters can then be realized by plastically deforming the connecting part in such a way that it is in contact with the insulation of the cable with a larger inner diameter than the inner diameter that is in contact with the stranded wire.

For the subsequent joining of the connecting part with the connection wire, in particular the outer circumference of the connecting part is formed. This creates the geometric prerequisites for a preferably flat welding surface for the connection wire on the bond between the stranded wire conductor and the connecting part. After forming, the inner contour of the connecting part or the inner profile of the connecting part is preferably congruent with the outer contour or the outer profile of the stranded wire in the area of the removed insulation and, in particular, with the outer contour or the outer profile of the cable in the area of the insulation. When forming the connection part, it is preferably pressed firmly against the insulation so that a gas-tight bond is preferably formed between the inner wall of the connection part and the outer wall of the insulation.

During connection, the connecting part is preferably first placed around the stranded wire in a positive fit and then welded to the stranded wire, in particular ultrasonically welded or resistance welded. With the aid of welding tools, in particular with anvils and sonotrodes for ultrasonic welding or electrodes for resistance welding, both forming and material-locking joining between connecting part and stranded wire can be achieved. The tools can first be used to form the connecting part so that a positive connection is formed between the connecting part and the stranded wire. This preferably creates a direct contact surface between the connecting part and the stranded wire, which forms a welding plane for welding the connecting part to the stranded wire. Welding can take place after or during this forming process by conducting welding energy into the welding plane between the stranded wire and the connecting part. The welding plane is preferably the outer sheath surface of the stranded wire and the inner sheath surface of the connecting part, which are in contact with each other after forming.

Forming can also be carried out in such a way that after forming the cross-section profile of the connecting part is different on the outside than on the inside. The inner cross-sectional profile of the connecting part is preferably congruent with the stranded wire or cable and, for example, round, whereas the outer contour or the outer profile or cross-sectional profile of the connecting part after forming is preferably angular, in particular polygonal, for example hexagonal or square. This edge shape is particularly suitable for applying the welding tools to the outer circumference of the connecting part.

A seam of the connecting part is preferably located in the area of a flat surface and not in the area of an edge of the multi-edged shape of the connecting part. This ensures that the seam is securely welded during welding. In particular, the seam formed on the connecting part after the sleeve has been turned over or joined is on the outer surface on which the welding tools engage. Welding energy can be introduced into the welding plane between the connecting part and the stranded wire and at the same time the welding energy can be introduced into the seam. Thus, in a single welding process, the connection part can be welded along its seam and at the same time the connection part can be welded to the stranded wire.

It has been found that in ultrasonic welding with geometrically adapted welding tools, in particular sonotrodes and anvils, the connecting part can first be plastically formed around the stranded wire in a form-fitting manner and then connected to it in a material-fit manner. Welding can take place after or during the forming process. Due to the forming and joining with one tool, a high cycle time is possible with a simple and robust system technology at the same time. Only a few process parameters need to be set and the process can be carried out economically.

It is also possible to first use a crimping process to form-fit the connection part to the stranded wire and then use an ultrasonic welding process to connect the connection part to the stranded wire. With this material-locking connection, an oxide layer can be broken on the stranded wire and/or the connecting part.

Another aspect is a method according to claim 16.

As already explained, the connecting part can be placed around the stranded wire. When the connecting part is then positively joined to the stranded wire, at least the connecting part, preferably also the stranded wire, can be plastically deformed in order to ensure a good mechanical connection between the stranded wire and the connecting part along the inner circumference of the connecting part and at the same time, for example, to plastically form the connecting part on its outer circumference for subsequent welding with a connection wire. In particular, flat welding surfaces can be formed on the outside of the connecting part, along which the welding tools make it particularly easy to weld the connecting part to the stranded wire, as well as to subsequently weld the connecting part to a connection wire.

The connecting part is placed around the stranded wire as explained. The connection part is preferably already cut to length or is cut to length after it has been turned over. The seam can then be a butt joint or an overlap joint. Welding is then carried out in such a way that the welding tools are placed on the seam of the butt joint or the lap joint, which is preferably first plastically deformed, and then both the seam and the connecting piece are welded to the stranded wire along this seam. Ultrasonic welding tools as well as resistance welding tools can be used.

In the following, the subject matter is explained in more detail by means of a drawing showing embodiments. In drawing show:

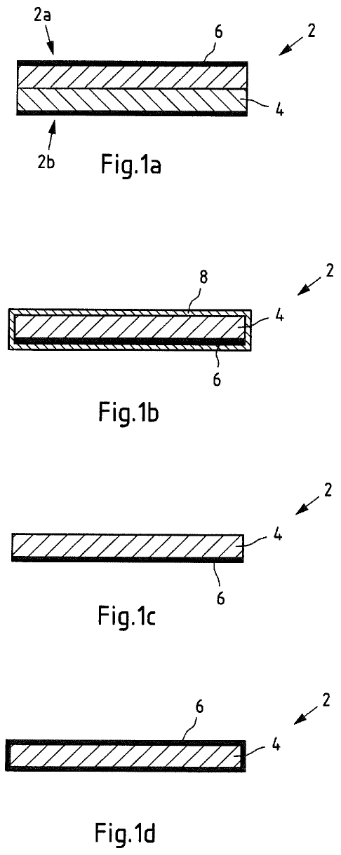

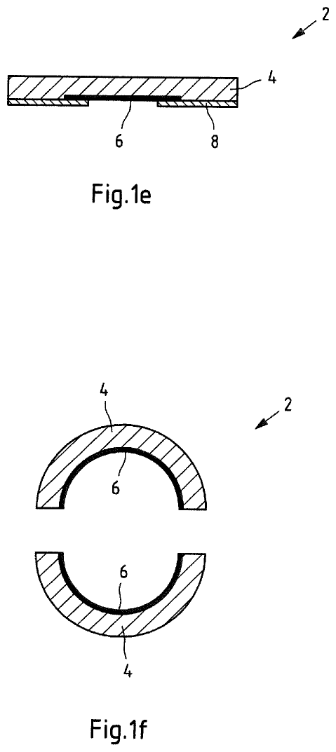

FIG. 1a-f various embodiments of connection parts;

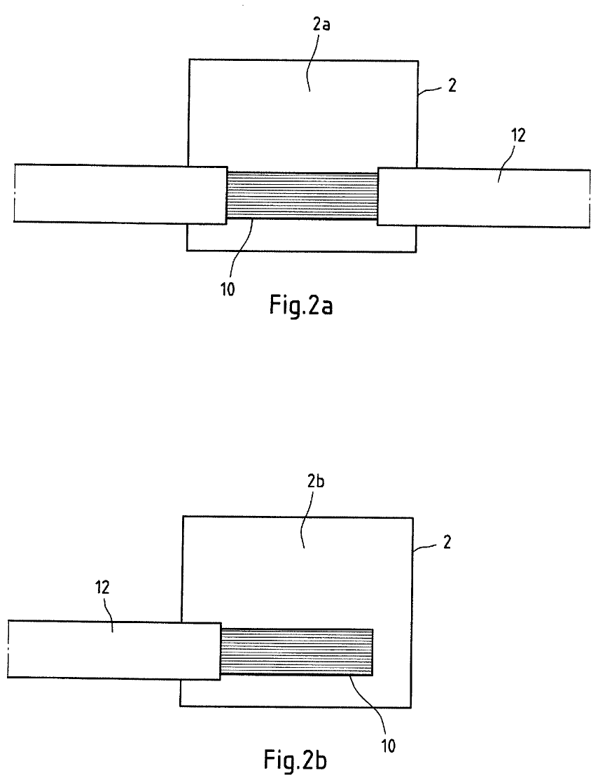

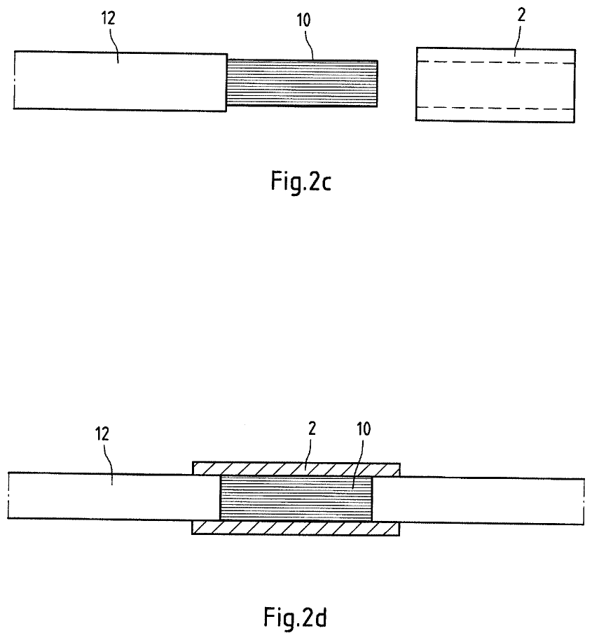

FIG. 2a-d various embodiments of a connection part with a cable comprising a stranded wire;

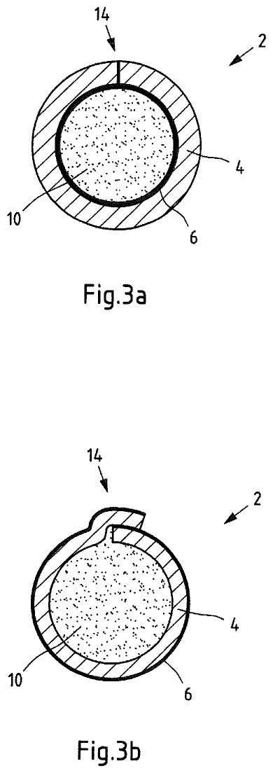

FIG. 3a, b a cross section through a stranded wire joined with a connecting part;

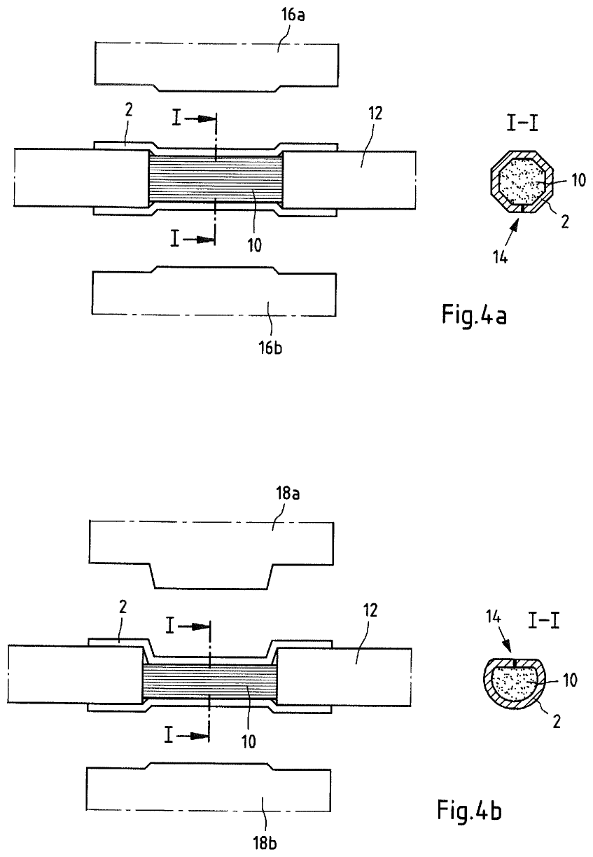

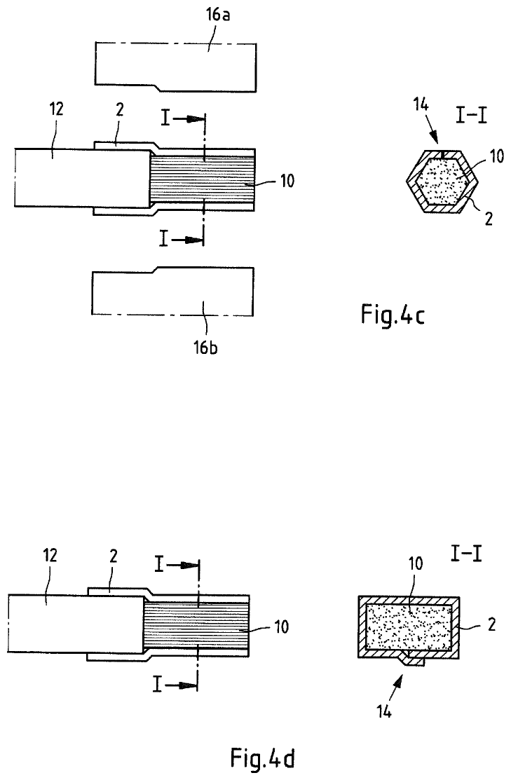

FIG. 4a-d embodiments for welding the connecting part to the stranded wire;

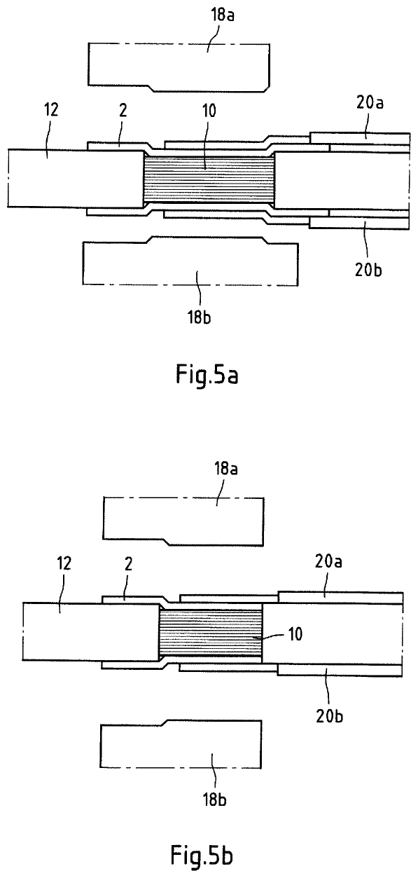

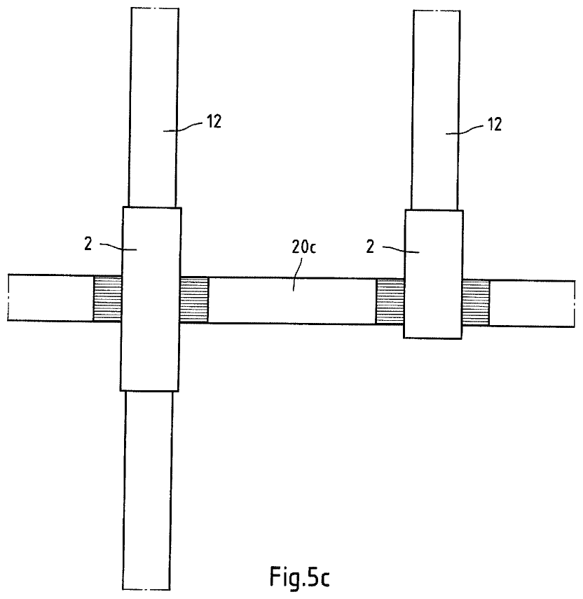

FIG. 5a-c embodiments for welding the connecting part to a connection wire.

FIG. 1a shows a connecting part 2 in a cross-section. The connection part 2 has two surfaces 2a and 2b, which are made of different metal materials. The connecting part 2 according to FIG. 1a is, for example, a bimetallic sheet metal strip with a carrier material 4 and a coating material 6. The transition between the carrier material 4 and the coating material 6 is characterised by a standard potential difference. This is preferably larger than one volt.

The carrier material 4 can, for example, be an aluminium material or a copper material. All alloys of aluminium and copper can be used as carrier material. The coating material 6 can also be a copper material or an aluminium material as well as all alloys belonging to it. Also the coating material can be 6 nickel.

FIG. 1b shows another embodiment of a connection part 2, where carrier material 4 and coating material 6 are coated on all sides with a further material 8. In particular, material 8 may be a nickel material.

FIG. 1c shows another embodiment of a connection part 2, where the carrier material 4 can be formed as a sheet and the coating material 6 can be, for example, a nickel coating in particular. The coating can be a galvanic coating.

FIG. 1d shows another embodiment of a connection part 2, where a carrier material 4 can be coated on all sides with a coating material 6. Here, the coating material 6 can preferably be a nickel layer.

FIG. 1e shows another embodiment of a connection part 2. Here a carrier material 4 can be provided with a coating material 6 arranged on it or embedded therein, in particular roll clad coating material 6. A transition between the carrier material 4 and the coating material 6 can, for example, be coated with a coating 8, which is, for example, nickel. The coating material 6 may be free of the coating 8 at a distance from the transition between the substrate 4 and the coating material 6.

FIG. 1f shows another embodiment of a connection part 2. This is formed as a two-part sleeve in which carrier material 4 and coating material 6 are provided on both sleeve parts. It is not shown that the sleeve can also be fully coated, e.g. with nickel.

The above statements for the material combinations for carrier material 4 and coating material 6 apply to all conceivable connecting parts. In particular, further material combinations are possible, in particular by using stainless steel or similar materials. A joining between the connecting part 2 and a stranded wire 10 of a cable 12 is shown as an example in FIG. 2a.

Depending on the application and the material of the stranded wire 10, a connecting part according to FIG. 1a-f can be placed either with the surface 2a or the surface 2b on the stranded wire 10 or with the carrier material 4 or the coating material 6 on the stranded wire 10.

Here it is possible that the cable 12 is spliced so that the stranded wire 10 is exposed between two insulated areas of the cable 12. The connecting part 2 is now placed around such an area. In this case, connection part 2 with one of the surfaces 2a, b is placed on the stranded wire 10 and then turned over. Connection part 2 can be cut to length before the cover is turned over, or it can be cut to length after the cover is turned over.

FIG. 2b shows an embodiment in which the connection part 2 is laid around the stranded wire 10 at one end of the cable 12 which is stripped at the end face. Here, too, it depends on which material the stranded wire 10 is made of, which of the surfaces 2a, b of connection part 2 is laid on the stranded wire 10. Copper materials or aluminium materials are particularly suitable for stranded wire 10.

FIG. 2c shows how a sleeve 2 is pushed on or put on, for example according to FIG. 1f on a front end of a cable 12 in which the stranded wire 10 is stripped.

According to FIG. 2d, cable 12 is spliced so that sleeve 2 is exposed between two insulated areas of cable 12. The sleeve 2 is now pushed onto such an area or, in the case of a multi-part sleeve, placed onto it. The sleeve with one of the surfaces 2a, b is placed on the stranded wire 10 and then pressed.

After connecting part 2 to the stranded wire 10, it is plastically deformed and laid around the stranded wire. A cross-section of such an at least mechanically joined connection between the connecting part 2 and the stranded wire 10 is shown in FIG. 3a. Here the coating material 6 is on the side of connection part 2 facing the stranded wire 10 and the carrier material 4 is on the side of connection part 2 facing away from the stranded wire 10. Plastic deformation of connection part 2 produces a positive connection at the transition between the coating material 6 and the stranded wire 10. Connection part 2 is laid in a butt joint around the stranded wire 10 and a seam 14 is formed.

FIG. 3b shows another embodiment in which, for example, the carrier material 4 is arranged on the side of connection part 2 facing the stranded wire 10 and the coating material 6 on the side of connection part 2 facing away from the stranded wire 10.

The connection part 2, for example, has been laid around the stranded wire 10 and then cut to length. The seam 14, for example, is shaped as an overlap joint.

FIG. 4a shows the joining of the connection part 2 to the cable 12. FIG. 4a shows two press jaws 16a, 16b as examples with which the connection part 2 can be joined to the cable 12 plastically deforming. To do this, the press jaws 16a, b move in the direction of connection part 2 and deform it in the process. The cross-section I-I is shown in FIG. 4a on the right. As can be seen, a contour of the connecting part 2, for example, is given with the aid of the press jaws 16a, b. In the example shown, the connecting part 2 has a multi-edged outer contour after being pressed through the pressing jaws 16a, b. In addition, connection part 2 is directly connected to the stranded wire 10.

Furthermore it can be seen in FIG. 4a that connection part 2 is also pressed against cable 12 in the area of the insulation of cable 12. The pressing jaws 16a, b can be shaped in such a way that a positive and preferably gas-tight connection is formed between the connecting part and the insulation of the cable 12.

The seam 14 of connection part 2 can also be seen in FIG. 4a. Seam 14 is located in the area of a flat surface of the outer circumference of connector 2. In particular, seam 14 is located in the area of a welding plane with which connector 2 is welded to the stranded wire line 10. The pressing jaws 16a, b can also be formed as ultrasonic tools, in particular as anvils and sonotrodes, and enable the connection part 2 to be welded to the stranded wire 10 as well as along the seam 14 immediately during the pressing described in FIG. 4a.

FIG. 4b shows another example in which a sonotrode 18a and an anvil 18b work in a similar manner to the press jaws 16a, b according to FIG. 4a. The contour of sonotrode 18a and anvil 18b can also be such that the cross-section along the section plane I-I of connector 2 is angular after deformation. Here, too, it can be seen that the seam 14 is in the area of a flat welding surface. With the help of the sonotrode 18a and the anvil 18b it is possible to first form the connection part 2 around the stranded wire 10 and then or in the same working step weld it to the stranded wire 10. This allows simultaneous welding along the seam 14.

FIG. 4c shows another example. Pressing jaws 16a, b or sonotrode 18a and anvil 18b can be used to press connection part 2 onto the stranded wire 10 and, if necessary, weld it simultaneously or afterwards. The pressing jaws 16a, b shape the cross-section along the section I-I as shown in FIG. 4c. Here, too, flat welding surfaces are formed. Seam 14 can be provided within one of these welding surfaces.

FIG. 4d shows another example in which the connecting part 2 is pressed against the stranded wire 10 and the insulation of the cable 12. At section I-I is shown, outer circumference e.g. can be square and especially seam 14 can be build as overlap-joint.

After joining the connecting part 2 to the stranded wire 10 with positive and material locking, in particular by means of ultrasonic welding or resistance welding, and if necessary to the insulation of the cable 12 with positive locking, it is possible to lay connecting lines 20a, b on the preferably flat welding surfaces on the outer circumference of the connecting part 2. This connection wire 20a, 20b can be welded with their exposed ends or their stranded wires to a surface 2a, b of the connection part 2 as shown in FIG. 5a.

The stranded wire 10 is preferably made of a different metal material than the connection wires 20a, b.

By the fact that the connecting part 2 is formed from a carrier material 4 and a coating material 6, which are formed from different materials, a smaller standard potential difference results at the transition between the outwardly facing surface of the connecting part 2 to the connecting line 20a, b than a direct connection of the connecting lines 20a, b to the stranded wire 10.

FIG. 5b shows another embodiment in which the connecting part 2 is laid sleeve-shaped around one end of a cable 12 or the stranded wire. Here, too, the connection wires 20a, b preferably by means of a sonotrode 18a and an anvil 18b are welded to the outer surface of the connecting part 2. Here, too, connection part 2 has a first surface that faces the stranded wire 10 and a second surface that faces the connection wires 20a, b. The first surface faces the stranded wire 10. These surfaces are made of different materials, in particular carrier material 4 on the one hand and coating material 6 on the other.

The largest standard potential difference is preferably formed within the connecting part 2 at the transition between the carrier material 4 and the coating material 6, whereas the potential differences between on the one hand the stranded wire 10 and the carrier 4 or the coating material 6 and on the other hand the material of the stranded wire of the connection wire 20a, b and the material of the carrier material 4 or the coating material 6 are smaller.

FIG. 5c shows another example where the stranded wire 10 is connected to a flat cable 20c via the connection part 2. The cable of the connection wire 20c is free of its insulation in a central area. In this exposed area, the connecting part can be connected to the connection wire 20c with one of the surfaces 2a, b with material connection. The connection part 2 encloses the stranded wire 10 and is connected to it by a material connection.

At least two or more exposed areas can be provided along the 20c flat cable. At these areas, the stranded wires 10 can be connected in substance in the various configurations described above. Thus, a first stranded wire 10 can be spliced and in the area of the splice, connection part 2 can establish the connection with the flat cable, as shown on the left. The stranded wire 10 can also be provided with a sleeve as connection part 2 at the end face, for example, and a connection can be made to the flat cable 20c via this, as shown on the right.

With the help of the joining process shown, contact corrosion-proof joining by means of ultrasonic welding or resistance welding is possible. Cables made of different materials can be joined in a particularly simple way using a bimetal connection part.

1-19. (canceled)

20. Connection of a connection wire with a stranded wire, where a connecting part has a first metallic surface of a first metal material and a second metallic surface of a second metal material different from the first metal material,
the stranded wire is made of a metal material,
the connecting part is laid around the stranded wire to sheath the stranded wire, with the first metallic surface adjacent to the stranded wire, and
the connecting part is at least positively connected to the stranded wire, wherein
the connecting part with the second metallic surface facing away from the stranded wire is connected to the connection wire in a material-locking manner wherein
the connecting part is laid around the stranded wire as a cut-to-length strip, or in that the connecting part is laid around the stranded wire from an endless belt and is then cut to length.

21. Connection according to claim 20, wherein the amount of the standard potential difference between the first metal material and the second metal material is greater than 1V, preferably greater than 1.5V, and in particular in that the amount of the standard potential difference between the first metal material and the second metal material is less than 2V.

22. Connection according to claim 20, wherein one of the metal materials has a positive standard potential with respect to a normal hydrogen electrode and the other metal material has a negative standard potential with respect to a normal hydrogen electrode.

23. Connection according to claim 20, wherein the amount of the standard potential difference between the metal material of the connecting line and the second metal material is less than 1.5 V, preferably less than 1 V.

24. Connection according to claim 20, wherein the connecting part is coated bimetallically or in that the connecting part is roll clad bimetallically or in that the connecting part is formed as a bimetallic sheet metal part.

25. Connection according to claim 20, wherein the first metal material is formed from a metallic carrier material and the second metal material is formed from a metallic coating material or the first metal material is formed from a metallic coating material and the second metal material is formed from a metallic carrier material.

26. Connection according to claim 20, wherein the first metal material is copper, a copper alloy, aluminium, an aluminium alloy or stainless steel and/or the second metal material is copper, a copper alloy, aluminium, an aluminium alloy or nickel and/or in that the connection wire is formed from copper, a copper alloy, aluminium or an aluminium alloy.

27. Connection according to claim 20, wherein the conductor cross-section of the stranded wire is greater than 50 mm² and less than 200 mm².

28. Connection according to claim 20, wherein the stranded wire is an energy conductor in a motor vehicle, in particular a battery conductor.

29. Connection according to claim 20, wherein the stranded wire is guided in a cable with insulation, and in that the connection between the stranded wire and the connecting part is formed in the region of an uninsulated region of the cable which is surrounded on both sides by the insulation, or in that the connection between the stranded wire and the connecting part is formed in the region of a stripped end of the cable.

30. Connection according to claim 20, wherein the connecting part is crimped around the stranded wire, in particular in that the connecting part in the region of an insulation has an inner circumference corresponding to the outer circumference of the insulation, in particular in that the connecting part is arranged gas-tight on the insulation and/or in that the connecting part in the region of the stranded wire has at least one flat surface region pointing outwards, a seam of the connecting part in particular being arranged in at least one flat surface region.

31. Connection according to claim 20, wherein the connecting part is wrapped around the stranded wire in a positive fit and in that the connecting part is welded to the stranded wire, in particular ultrasonically welded or resistance welded.

32. Connection according to claim 20, wherein the connecting part has a polygonal outer circumference, at least two outer edges being formed as welding faces for a material-locking connection between the connecting part and the connecting line.

33. Connection according to claim 29, wherein that the connection wire is arranged in the region of the joint with the connecting part parallel to the stranded wire on the insulation of the cable comprising the stranded wire.

34. Method of connecting a connecting part to a stranded wire, the method comprising:
laying the connecting part with a first metallic surface made of a first metal material around the stranded wire in a positive fit, wherein the connecting part is laid around the stranded wire as a cut-to-length strip, or in that the connecting part is laid around the stranded wire from an endless belt and is then cut to length to form a cut-to-length strip;
welding the connecting part to the stranded wire in a material-locking manner; and
connecting a connection wire in a material-locking manner to a second metallic surface of the connecting part, wherein the second metallic surface is made of a second metal material which faces away from the first metallic surface.

35. Method according to claim 34, wherein the connecting part and the stranded wire are plastically deformed before or during the material-locking connection.

36. Method according to claim 34, wherein the connecting part is welded to the stranded wire in the region of a butt joint or an overlap joint.

37. Method according to claim 34, wherein the welding comprises ultrasonic welding.

38. Method according to claim 34, wherein the welding comprises resistance welding.
